(19) United States
(12) Patent Application Publication
(10) Pub. No.: US 2009/0254368 A1
(43) Pub. Date: Oct. 8, 2009

(54) Method of providing enhanced point of service care

(76) Inventor: David D. Cunnold, Alpharetta, GA (US)

Correspondence Address: CONLEY ROSE, P.C., 5601 GRANITE PARKWAY, SUITE 750, PLANO, TX, 75024, US

(21) Appl. No.: 11/723,181

(22) Filed: Mar. 16, 2007

Related U.S. Application Data
(60) Provisional application No. 60/782,528, filed on Mar. 16, 2006.

(51) Int. Cl. G06Q 50/00

(52) U.S. Cl. 705/3

(57) ABSTRACT

A method for enhancing the quality of care for enrollees of drug prescription programs is disclosed. The method utilizes a pharmacist operating in “real-time” to improve the quality of care and reduce cost for receivers of prescription drugs with chronic diseases. The method of the invention is a significant improvement over traditional disease management models that currently are known in the art.

### REFERENCE TO RELATED APPLICATION

The present application claims priority to provisional application Ser. Number No. 60/782,528 filed on Mar. 16, 2006 and entitled “Method of Providing Enhanced Point of Service Care.”

### BACKGROUND OF THE INVENTION

The present invention is generally related to the field of health care delivery systems, and more particularly, is directed to a method for enhancing the quality of care at reduced cost for enrollees of drug prescription programs.

The wide spread use of computers and the emergence of the Internet has lead to a revolution in data collection, storage and distribution. Herein, the terms “data” and “information” are used interchangeably. Today, most organizations could not conduct their affairs without the aid of computerized information systems, which help to collect, process, and distribute information. Such systems are taken for granted as a necessity for conducting business on even a modest scale.

Prior to the advent of personal computers and computer networks, most information was collected manually and stored in hard copy form in physical file drawers. Because there were usually no more than one or two copies of each document, their location and safeguarding were easy to control. Even when mainframe computers became available, the information had to be manually collected and in many cases manually entered into the computer as well.

Access to the stored information was limited. The information could only be retrieved by outputting to an associated terminal unit, printer and/or magnetic tape drive. Security of the information usually was not an issue as the entire computer infrastructure was under the control of the business owner. Moreover, very few employees had the skill set necessary to operate the computer system. Thus, security was enhanced because only a limited number of trusted employees had sufficient knowledge to gain access to information stored on the mainframe computer. Because in house mainframe computers typically were not networked with outside computers, security was further enhanced. Thus, the likelihood that the computer would be “hacked” from the outside was greatly reduced. Thus, a company's physical infrastructure and the lack of networking with other computers provided the ultimate firewall. Accordingly, the company and it customers felt secure from unauthorized access to company records.

Today, the situation is much different. The relationship that most customers have, for example, with their bank or other service provider, allows the customer online access to his or her records. In most cases the customer can see their complete records and update out-of-date information if necessary. Both the customer and the service provider benefit from the relationship.

While the benefits of conducting business transactions that involve confidential information online are many, these benefits give rise, to many security challenges. The challenges are two-fold. The first challenge is to deny entry to those who are not authorized to gain access to the system. The second challenge is maintaining the privacy of user information once it has been collected and stored in the system. While neither of these challenges is new, they have been greatly aggravated and made more difficult by the number of people and commercial establishments who now use online systems and the amount of data that these systems collect and store.

Due to their sensitivity, the confidentiality of medical records is of particular concern when online systems are used. With modern encryption techniques, advanced firewalls and sophisticated password security, online systems are today considered to be very safe. Their use with respect reducing the cost and increasing the quality of the delivery of health care services offers a number of advantages which the present invention exploits.

### SUMMARY OF THE INVENTION

The present invention takes advantage of the convenience and efficiency of online systems to improve and reduce the cost of health care delivery. The system has particular application in the dispensing of prescription drugs and the interaction between the pharmacist, the patient and those who are responsible for paying for the costs, in most cases, insurance companies.

The Medicare Modernization Act of 2003 requires prescription drug plans and Medicare Advantage Drug Plans to include medication therapy management (MTM) as part of their Part D coverage under the Act to help control costs and improve quality of care. The MTM services target Medicare Part D beneficiaries with multiple chronic conditions taking multiple medications and who are likely to incur high drug costs as defined by the Act.

Under the Act, licensed pharmacists are designated as MTM service providers. The provider's service may be distinguished between services in ambulatory and institutional settings but must be developed in cooperation with licensed and practicing pharmacists and physicians. The service must also be coordinated with a care management plan established for the targeted individual under a Medicare CCI program.

The method of providing enhanced point of care service of the present invention utilizes the pharmacist operating in “real-time” to improve the quality of care and reduce cost for receivers of prescription drugs (“enrollees”) with chronic diseases. The method of the invention is a significant improvement over traditional disease management models that currently exist in the marketplace.

The advantages and benefits that the method of the invention offers over prior methods include:

Real-time notification of available encounters for pharmacists;

pharmacist (trusted provider) become a central care provider;

All enrollees utilize drugs from a pharmacy and visit pharmacists more than any other care provider;

No addresses or phone numbers of enrollees are required - encounters occur as the enrollees pick up medications;

Pertinent data is available via the Internet to assist the provider with managing the enrollee's chronic condition—i.e. all potential encounters, gaps in care, and history are provided to the pharmacist at the point of service with appropriate information for the pharmacist to help build a relationship with the enrollee and to improve the enrollee's quality of care.

On a nightly basis, the user of the method of the invention, i.e, the “Service Integrator”, provides its switch vendor, such as NDCHealth, with a file of target encounters. The Service Integrator has already applied many rules to the data in order to identify the specific targeted enrollees, encounters, and business specifications. Thus, the switch vendor loads this file and scans all the pharmacy drug claims that are submitted from pharmacies to the pharmacy benefit management company (“PBM”) throughout the day. Since the switch vendor is the “middle man” for most pharmacy claim transactions throughout the United States, they are the perfect partner to identify when an enrollee is in the pharmacy and to provide a message on the pharmacy transaction to the submitting pharmacy.

The method of the present invention allows the automation of the traditional disease management model using the pharmacy point of sale real-time interface with pharmacies. Such a method allow the replacement of the traditional “care manager” with an active pharmacy provider.

### BRIEF DESCRIPTION OF THE DRAWING

The present invention may be more completely understood in consideration of the following detailed description of various embodiments of the invention in connection with the accompanying drawing, in which:

FIG. 1 is a diagram illustrating the general architecture of the method of the present invention.

### DESCRIPTION OF THE PREFERRED EMBODIMENT

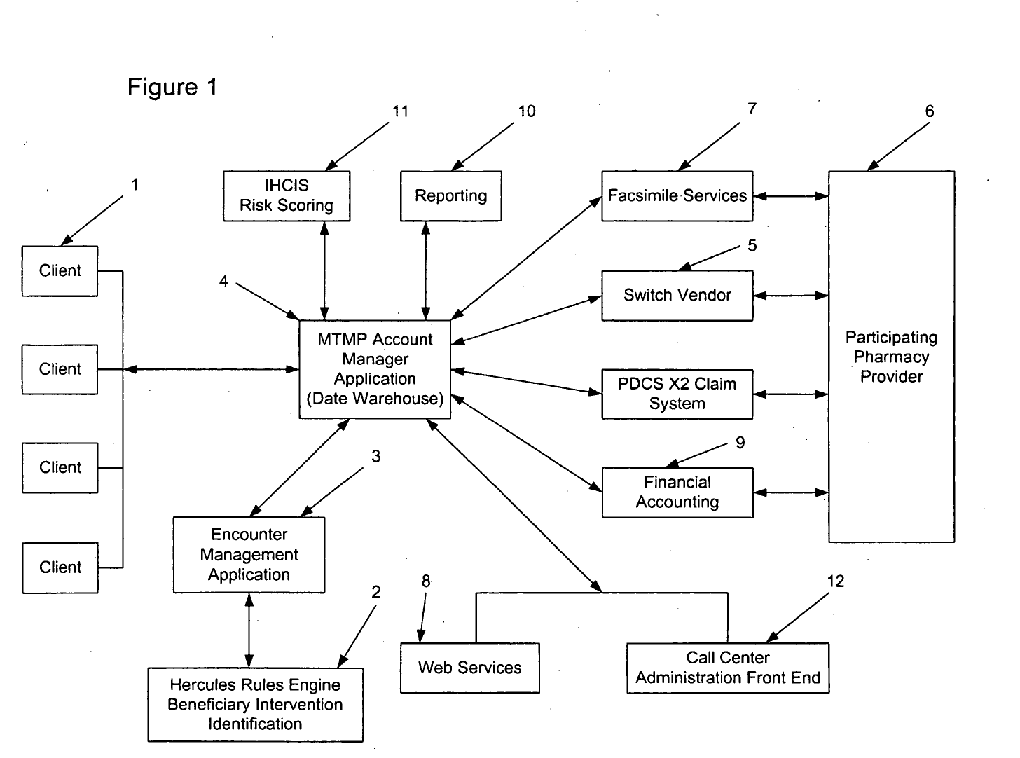

A preferred embodiment of the present invention will not be described in with reference to FIG. 1 of the drawing.

In accordance with the invention, clients 1 provides medical claims, pharmacy claims, and eligibility file to the System Integrator. The System Integrator then runs a Hercules rules engine 2 on a monthly basis to identify all enrollees that demonstrate non-compliance with the specifically designed TSDs. The file from Hercules engine 2 with the enrollee's identified interventions is loaded into a staging table for the Encounter Management Application 3. On a monthly basis, the MTMP Account Manager Application 4 reviews the Hercules results in Encounter Management Application 3, modifies the encounters to be posted or encounter priorities, and then runs Encounter Management Application 3 to populate the a Master Encounter Table in MTMP Application 4 which also includes a data warehouse. On a nightly basis, the System Integrator runs a script to review the Master Encounter Table and identify available enrollee interventions. Also, on a nightly basis, a file of the available enrollee interventions is sent to switch vendor 5. Throughout the day, switch vendor 5 reviews claim transactions from participating pharmacies 6. These transactions are for the client's drug claims which are processed by a pharmacy benefits management company. Switch vendor 5 reviews each transaction against the MTMP file provided by the System Integrator. When switch vendor 5 finds a match, it attaches the identified encounter code to the free text portion of the claim response. The switch vendor handles all encounter identification and response generation for point of sale claims.

On a near real-time basis (less than 15-minutes), switch vendor 5 provides the system user via SMTP a file of all identified encounters and responses provided to the pharmacies within the past 15-minutes. Once the system user receives the file of identified encounters from the switch vendor (every 15 minutes), the system loads the file into the Master Encounter Table and automatically generates a facsimile using facsimile service 7 to the appropriate pharmacy for each enrollee and encounter. The facsimile contains additional detail regarding the specific interventions identified for the enrollee's encounter. The facsimile also contains forms for the pharmacy to complete and all appropriate literature.

The pharmacist completes the intervention and then documents via, for example a website (using web services 8) or facsimile (using facsimile services 7). If a website is used, the pharmacy may log into the website and view the enrollees encounter, review the encounter instructions, and complete appropriate data elements. If a facsimile is used, the pharmacy may complete the fax questions and data elements and then send to the System Integrator via facsimile.

The pharmacist completes the intervention, the documentation, and then bills via:
Web—the pharmacy may log into the website and after documenting the intervention may submit the bill for payment for services using financial accounting services 9; or
Fax—the pharmacy may complete the fax and request payment for services using financial accounting services 9; or
Point of Services (POS)—the pharmacy may submit a NCPDP 5.1 transaction requesting payment for services using financial accounting services 9.

Based on the request for payments, etc, the system user pays the pharmacies bi-weekly. The data received from the pharmacies is used to determine which encounters need to be sent to switch vendor. This date may also be used for reporting and outcomes analysis.

The method of the present invention also provides number of reporting services 10, IHCIS risk scoring methodologies 11 and a call center administration front end 12.

The present invention should not be considered limited to the particular examples described above, but rather should be understood to cover all aspects of the invention as fairly set out in the attached claims. Various modifications, equivalents processes, as well as numerous structures to which the present invention may be applicable will be readily apparent to those of skill in the art to which the present invention is directed upon review of the instant specification.

We claim:

1. A method of improved quality of care for recipients of prescription drugs when the recipients visits a pharmacy, said method including the steps of:
storing all of said recipients prescription drug records in a central data store;
when the recipient visiting said pharmacy, said pharmacy retrieving the recipient's pharmacy records;
said pharmacy using said retrieved records to improve the quality of care for said recipient.
